(19) United States
(12) Patent Application Publication
(10) Pub. No.: US 2010/0277930 A1
(43) Pub. Date: Nov. 4, 2010

(54) LED LAMP ADAPTER AND LED LAMP STRUCTURE

(75) Inventors: YEN-FU LIU, TAIPEI COUNTY (TW); CHIEN-YANG CHIEN, TAOYUAN COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: ENERGYLED CORPORATION, TAIPEI COUNTY (TW)

(21) Appl. No.: 12/769,748

(22) Filed: Apr. 29, 2010

(30) Foreign Application Priority Data
May 1, 2009 (TW) 98207481

(51) Int. Cl. F21V 21/00

(52) U.S. Cl. 362/374

(57) ABSTRACT

An LED lamp structure includes a light-transmitting tube, a light-emitting module and two LED lamp adapters. The light-emitting module is received and positioned in the light-transmitting tube, and the two LED lamp adapters are respectively positioned on two opposite ends of the light-transmitting tube. Each LED lamp adapter includes a first assembly, an adapter element and a second assembly. The first assembly has a first hollow body and a plurality of first retaining portions. The adapter element has a substrate, and a plurality of second retaining portions selectively corresponding to the first retaining portions, at least two electrode pins passing through the substrate and combined with the substrate. The positions of the two front ends of the at least two electrode pins relative to the first assembly are adjustable by selectively mating the first retaining portions with the second retaining portions.

### BACKGROUND OF THE INVENTION

1. Field of the Invention

The present invention relates to an LED lamp adapter and an LED lamp structure, and more particularly, to an LED lamp adapter and an LED lamp structure for adjusting assembly angle.

2. Description of Related Art

The invention of the lamp greatly changed the style of building construction and the living style of human beings, allowing people to work during the night. Without the invention of the lamp, we may stay in the living conditions of ancient civilizations. Various lamps such as incandescent bulbs, fluorescent bulbs, power-saving bulbs and etc. have been intensively used for indoor illumination. These lamps commonly have the disadvantages of quick attenuation, high power consumption, high heat generation, short working life, high fragility, and being not recyclable. Hence, LED lamp or LED tube is created in order to solve the above-mentioned questions of the prior lamp.

However, when the LED tube of the prior art is installed on a lamp bracket, the light-projecting angle of the LED tube is fixed and can not be adjusted. In other words, the electrode pins electrically connected to the lamp bracket are fixed on two opposite sides of the LED tube, and thus when the electrode pins have been inserted into the lamp bracket, the light beams generated by the LED tube is fixed and cannot be adjusted. Therefore, the light-projecting angle of the LED tube cannot be corrected and cannot be adjusted according to the different requirements.

### SUMMARY OF THE INVENTION

One particular aspect of the present invention is to provide an LED lamp adapter and an LED lamp structure for adjusting assembly angle. Light-emitting angle of the LED lamp structure (such as T5 or T8 tube) can be adjusted by rotating a light-transmitting tube of the LED lamp structure relative to at least two LED lamp adapters. Hence, the light-emitting angle of the LED lamp structure can be adjusted by rotating the light-transmitting tube for correcting the deviation of the light-emitting angle.

In order to achieve the above-mentioned aspects, the present invention provides an LED lamp adapter, including: a first assembly, an adapter element and a second assembly. The first assembly has a first hollow body, a locking structure formed on one part of an outer surface of the first hollow body, and a plurality of first retaining portions disposed on a lateral end of the first hollow body and adjacent to the locking structure. The adapter element has a substrate, a plurality of second retaining portions selectively corresponding to the first retaining portions, at least two electrode pins passing through the substrate and combined with the substrate, and at least two conductive wires respectively electrically connected to two rear ends of the at least two electrode pins. The positions of the two front ends of the at least two electrode pins relative to the first assembly are adjustable by selectively mating the first retaining portions with the second retaining portions. The second assembly has a second hollow body and a locking structure formed on one part of an inner surface of the second hollow body. The adapter element is fixed between the first assembly and the second assembly by mating the locking structure of the first assembly with the locking structure of the second assembly.

In order to achieve the above-mentioned aspects, the present invention provides an LED lamp structure, including: a light-transmitting tube, a light-emitting module and two LED lamp adapters. The light-emitting module is received and positioned in the light-transmitting tube, and the two LED lamp adapters are respectively positioned on two opposite ends of the light-transmitting tube. Each LED lamp adapter includes a first assembly, an adapter element and a second assembly. The first assembly has a first hollow body, a locking structure formed on one part of an outer surface of the first hollow body, and a plurality of first retaining portions disposed on a lateral end of the first hollow body and adjacent to the locking structure. The adapter element has a substrate, a plurality of second retaining portions selectively corresponding to the first retaining portions, at least two electrode pins passing through the substrate and combined with the substrate, and at least two conductive wires respectively electrically connected to two rear ends of the at least two electrode pins. The positions of the two front ends of the at least two electrode pins relative to the first assembly are adjustable by selectively mating the first retaining portions with the second retaining portions. The second assembly has a second hollow body and a locking structure formed on one part of an inner surface of the second hollow body. The adapter element is fixed between the first assembly and the second assembly by mating the locking structure of the first assembly with the locking structure of the second assembly.

In order to achieve the above-mentioned aspects, the present invention provides an LED lamp adapter, including: a first assembly, an adapter element and a second assembly. The first assembly has a first hollow body, a locking structure formed on one part of an outer surface of the first hollow body, and a first retaining portion disposed on an inner surface of the first hollow body and adjacent to the locking structure. The first hollow body has a positioning gap. The adapter element has a substrate rotatably disposed on the first retaining portion, a second retaining portion movably positioned in the gap, at least two electrode pins passing through the substrate and combined with the substrate, and at least two conductive wires respectively electrically connected to two rear ends of the at least two electrode pins. The positions of the two front ends of the at least two electrode pins relative to the first assembly are adjustable by rotating the second retaining portion in the gap. The second assembly has a second hollow body and a locking structure formed on one part of an inner surface of the second hollow body. The adapter element is fixed between the first assembly and the second assembly by mating the locking structure of the first assembly with the locking structure of the second assembly.

In order to achieve the above-mentioned aspects, the present invention provides an LED lamp structure, including: a light-transmitting tube, a light-emitting module and two LED lamp adapters. The light-emitting module is received and positioned in the light-transmitting tube, and the two LED lamp adapters are respectively positioned on two opposite ends of the light-transmitting tube. Each LED lamp adapter includes a first assembly, an adapter element and a second assembly. The first assembly has a first hollow body, a locking structure formed on one part of an outer surface of the first hollow body, and a first retaining portion disposed on an inner surface of the first hollow body and adjacent to the locking structure. The first hollow body has a positioning gap. The adapter element has a substrate rotatably disposed on the first retaining portion, a second retaining portion movably positioned in the gap, at least two electrode pins passing through the substrate and combined with the substrate, and at least two conductive wires respectively electrically connected to two rear ends of the at least two electrode pins. The positions of the two front ends of the at least two electrode pins relative to the first assembly are adjustable by rotating the second retaining portion in the gap. The second assembly has a second hollow body and a locking structure formed on one part of an inner surface of the second hollow body. The adapter element is fixed between the first assembly and the second assembly by mating the locking structure of the first assembly with the locking structure of the second assembly.

Therefore, when each second assembly is rotated to separate from each first assembly, each adapter element can be rotated through any angle from 0˜180 degrees relative to each first assembly in order to adjust the assembly angle of every two electrode pins that would be electrically inserted in a lamp bracket.

In order to further understand the techniques, means and effects the present invention takes for achieving the prescribed objectives, the following detailed descriptions and appended drawings are hereby referred, such that, through which, the purposes, features and aspects of the present invention may be thoroughly and concretely appreciated; however, the appended drawings are provided solely for reference and illustration, without any intention that they be used for limiting the present invention.

### BRIEF DESCRIPTION OF THE DRAWINGS

FIG. 1A is a perspective, exploded, schematic view of the LED lamp structure according to the first embodiment of the present invention;

FIG. 1B is a partial, assembled, schematic view of the LED lamp structure according to the first embodiment of the present invention;

FIG. 1C is a perspective, assembled, schematic view of the LED lamp structure according to the first embodiment of the present invention;

FIG. 2A is a perspective, exploded, schematic view of the LED lamp structure according to the second embodiment of the present invention;

FIG. 2B is a partial, assembled, schematic view of the LED lamp structure according to the second embodiment of the present invention;

FIG. 2C is a perspective, assembled, schematic view of the LED lamp structure according to the second embodiment of the present invention;

FIG. 3A is a perspective, exploded, schematic view of the LED lamp structure according to the third embodiment of the present invention;

FIG. 3B is a partial, assembled, schematic view of the LED lamp structure according to the third embodiment of the present invention;

FIG. 3C is a perspective, assembled, schematic view of the LED lamp structure according to the third embodiment of the present invention;

FIG. 4A is a perspective, exploded, schematic view of the LED lamp structure according to the fourth embodiment of the present invention;

FIG. 4B is a partial, assembled, schematic view of the LED lamp structure according to the fourth embodiment of the present invention; and

FIG. 4C is a perspective, assembled, schematic view of the LED lamp structure according to the fourth embodiment of the present invention.

### DETAILED DESCRIPTION OF THE PREFERRED EMBODIMENTS

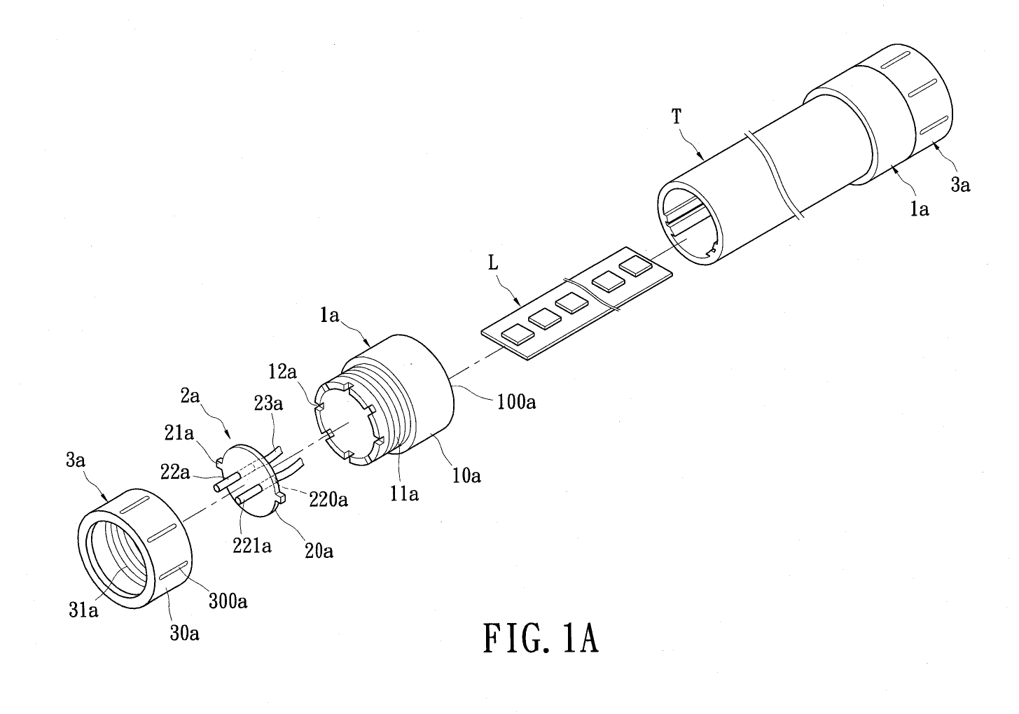

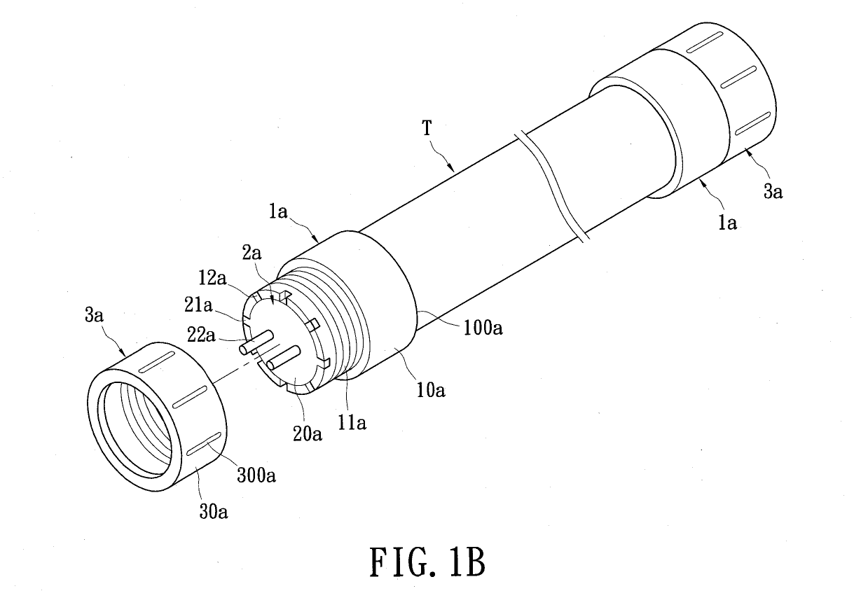

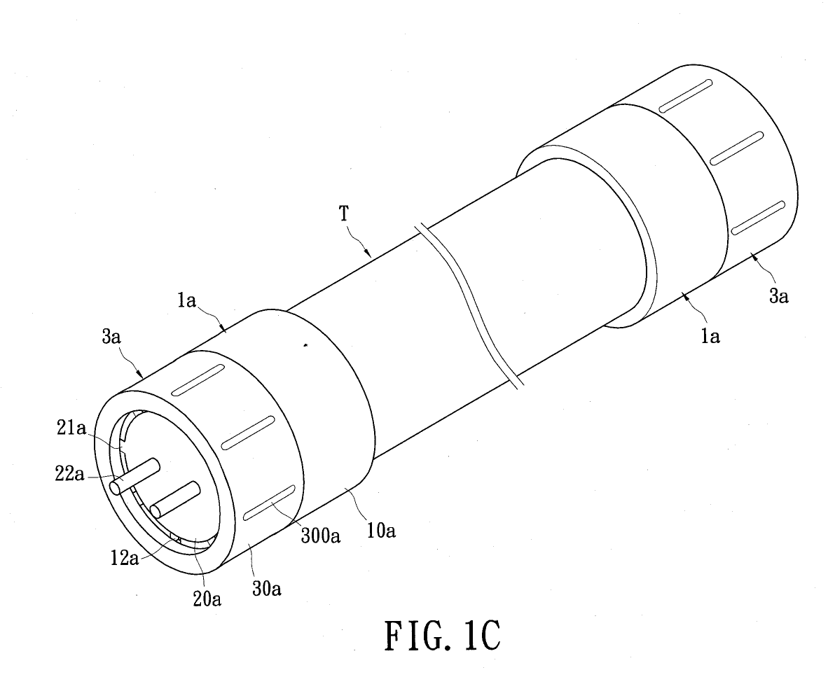

Referring to FIGS. 1A to 1C, the first embodiment of the present invention provides an LED lamp structure for adjusting assembly angle, including: a light-transmitting tube T, a light-emitting module L and two LED lamp adapters. The light-emitting module L is received and positioned in the light-transmitting tube T, and the two LED lamp adapters are respectively positioned on two opposite ends of the light-transmitting tube L.

Moreover, each LED lamp adapter includes a first assembly 1a, an adapter element 2a and a second assembly 3a.

The first assembly la has a first hollow body 10a, a locking structure 11a (such as a male screw) formed on one part of an outer surface of the first hollow body 10a, and a plurality of first retaining portions 12a disposed on a lateral end of the first hollow body 10a and adjacent to the locking structure 11a. In addition, the first hollow body 10a has a receiving space 100a communicated with another lateral end thereof. For example, each first retaining portion 12a may be a retaining groove disposed on the lateral end of the first hollow body 10a and adjacent to the locking structure 11a.

The adapter element 2a has a substrate 20a, a plurality of second retaining portions 21a selectively corresponding to the first retaining portions 12a, at least two electrode pins 22a passing through the substrate 20a and combined with the substrate 20a, and at least two conductive wires 23a respectively electrically connected to two rear ends 220a of the at least two electrode pins 22a. In addition, the positions of the two front ends 221a of the at least two electrode pins 22a relative to the first assembly 1a are adjustable by selectively mating the first retaining portions 12a with the second retaining portions 21a. For example, the number of the second retaining portions 21a may be two and each second retaining portion 21a may be a retaining body extended outwards from a periphery of the substrate 20a, and thereby the adapter element 2a can be fixed on one lateral side of the first assembly 1a by selectively mating the two retaining bodies (the two second retaining portion 21a) with any two of the retaining grooves (any two of the first retaining portions 12a).

The second assembly 3a has a second hollow body 30a and a locking structure 31a (such as a female screw) formed on one part of an inner surface of the second hollow body 30a. In addition, the adapter element 2a can be fixed between the first assembly 1a and the second assembly 2a by mating the locking structure 11a of the first assembly 1a with the locking structure 31a of the second assembly 3a. Moreover, the second hollow body 30a of the second assembly 3a has a plurality of stripped grooves 300a disposed around an outer surface thereof in order to increase friction force for user to firmly hold the second assembly 3a and assemble the second assembly 3a with the first assembly 1a.

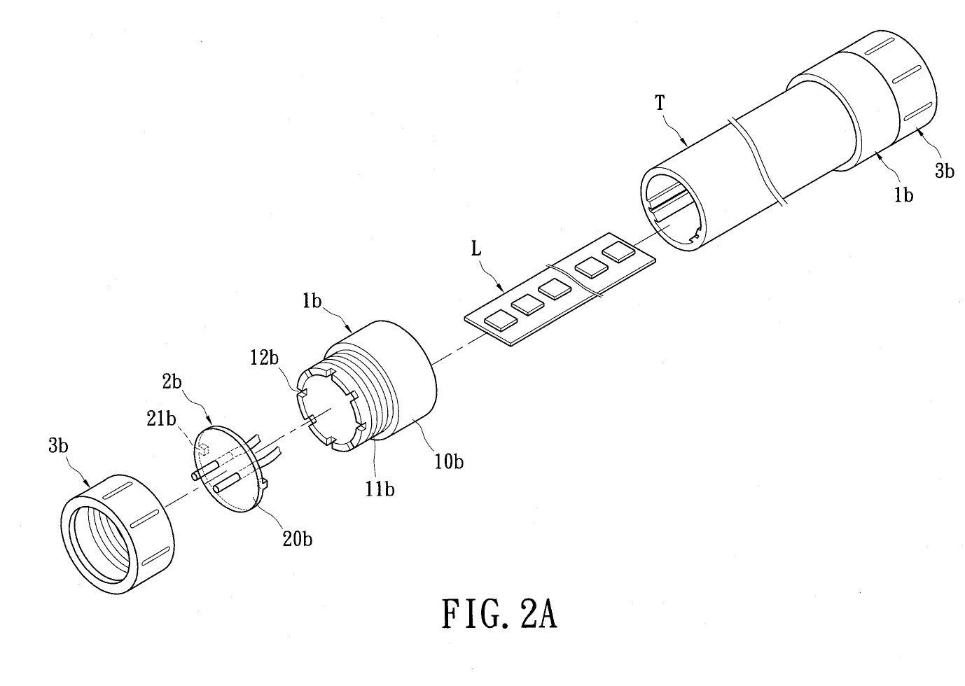

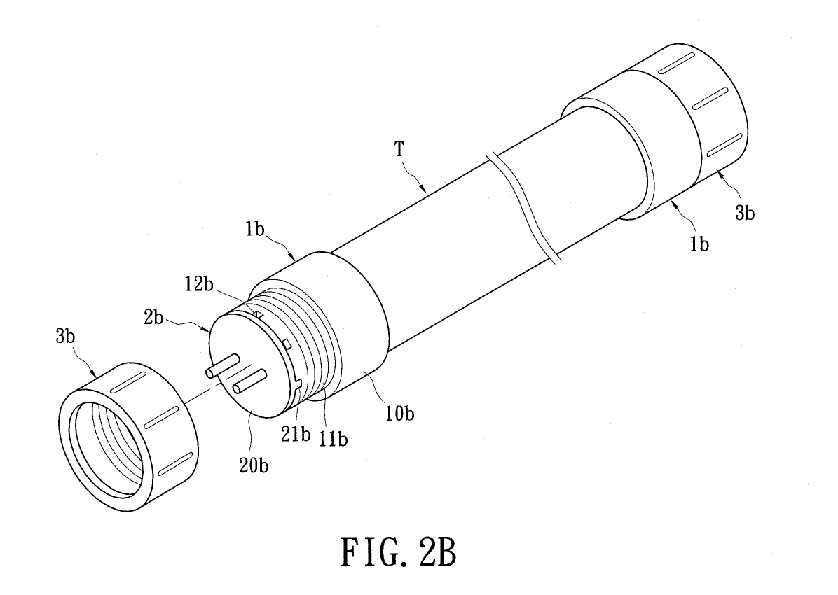

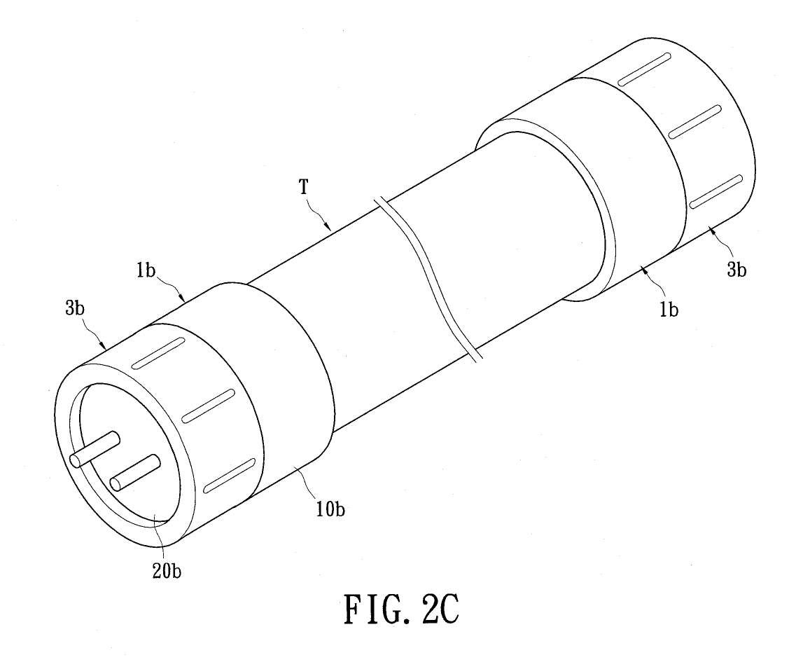

Referring to FIGS. 2A to 2C, the second embodiment of the present invention provides an LED lamp structure for adjusting assembly angle, including: a light-transmitting tube T, a light-emitting module L and two LED lamp adapters. The light-emitting module L is received and positioned in the light-transmitting tube T, and the two LED lamp adapters are respectively positioned on two opposite ends of the light-transmitting tube L.

Moreover, each LED lamp adapter includes a first assembly 1b, an adapter element 2b and a second assembly 3b. The difference between the second embodiment and the first embodiment is that: in the second embodiment, each first retaining portion 12b may be a retaining groove disposed on the lateral end of the first hollow body 10b and adjacent to the locking structure 11b. In addition, the number of the second retaining portions 21b may be two and each second retaining portion 21b may be a retaining body extended rearwards from a lateral surface of the substrate 20b, and thereby the adapter element 2b can be fixed on one lateral side of the first assembly 1b by selectively mating the two retaining bodies (the two second retaining portion 21b) with any two of the retaining grooves (any two of the first retaining portions 12b).

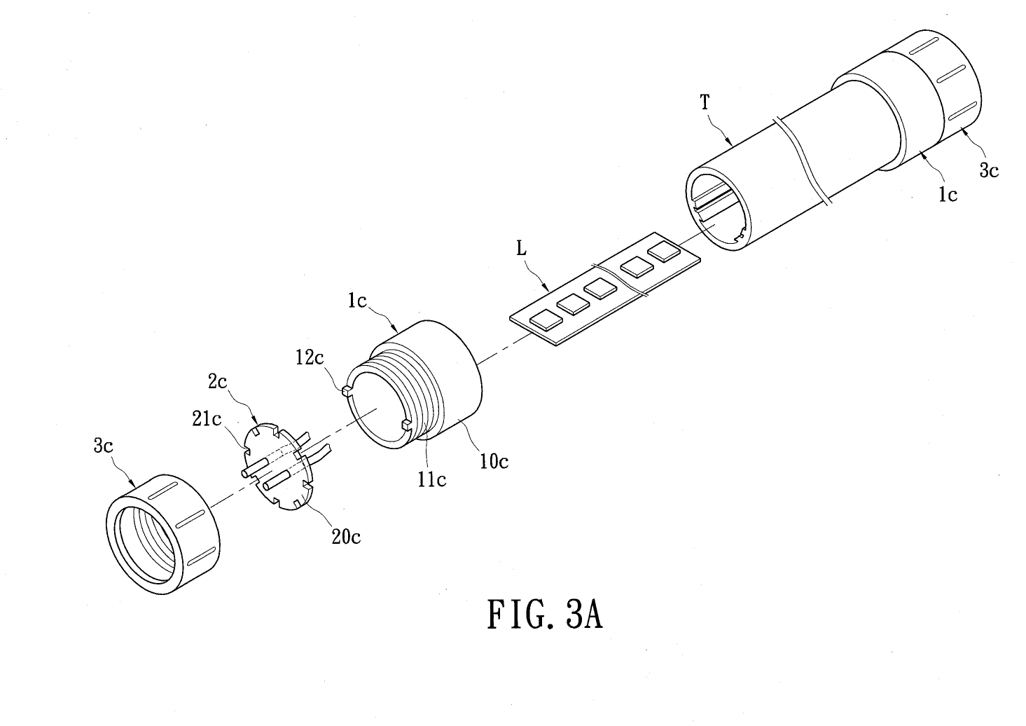

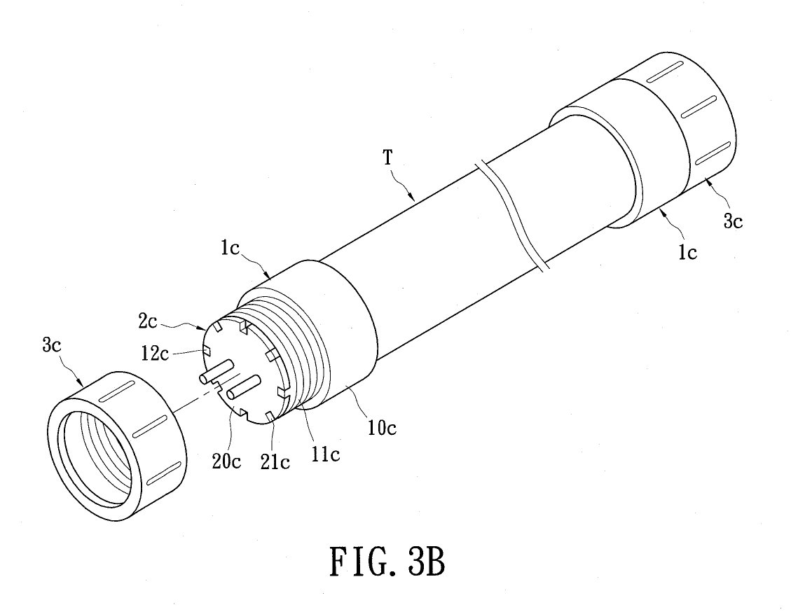

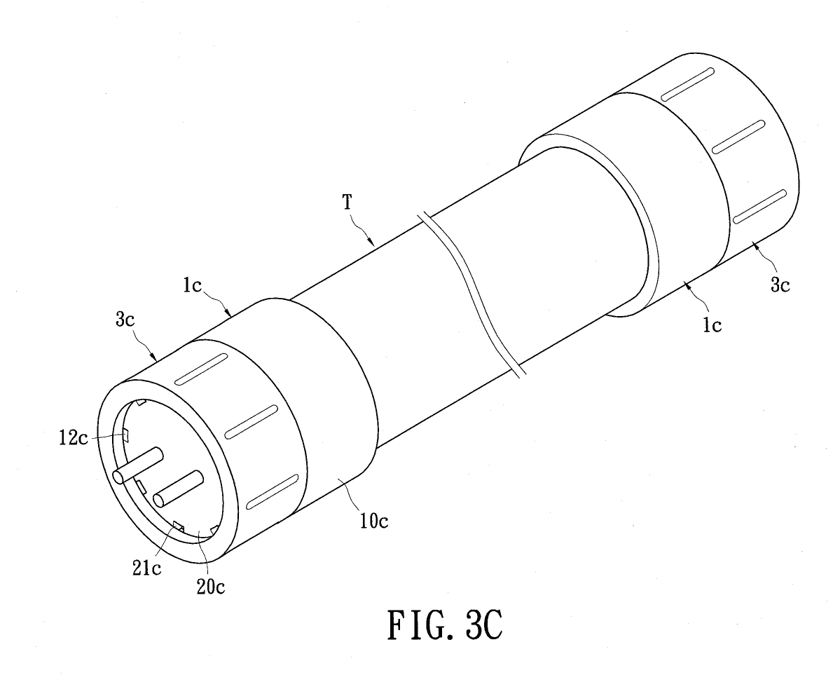

Referring to FIGS. 3A to 3C, the third embodiment of the present invention provides an LED lamp structure for adjusting assembly angle, including: a light-transmitting tube T, a light-emitting module L and two LED lamp adapters. The light-emitting module L is received and positioned in the light-transmitting tube T, and the two LED lamp adapters are respectively positioned on two opposite ends of the light-transmitting tube L.

Moreover, each LED lamp adapter includes a first assembly 1c, an adapter element 2c and a second assembly 3c. The difference between the third embodiment and the first and the second embodiments is that: in the third embodiment, the number of the first retaining portions 12c may be two and each first retaining portion 12c may be a retaining body adjacent to the locking structure 11c and extended outwards from the lateral end of the first hollow body 10c. Each second retaining portion 21c may be a retaining groove concaved inwards from a periphery of the substrate 20c, and thereby the adapter element 2c can be fixed on one lateral side of the first assembly 1c by selectively mating the two retaining bodies (the two second retaining portion 21c) with any two of the retaining grooves (any two of the first retaining portions 12c).

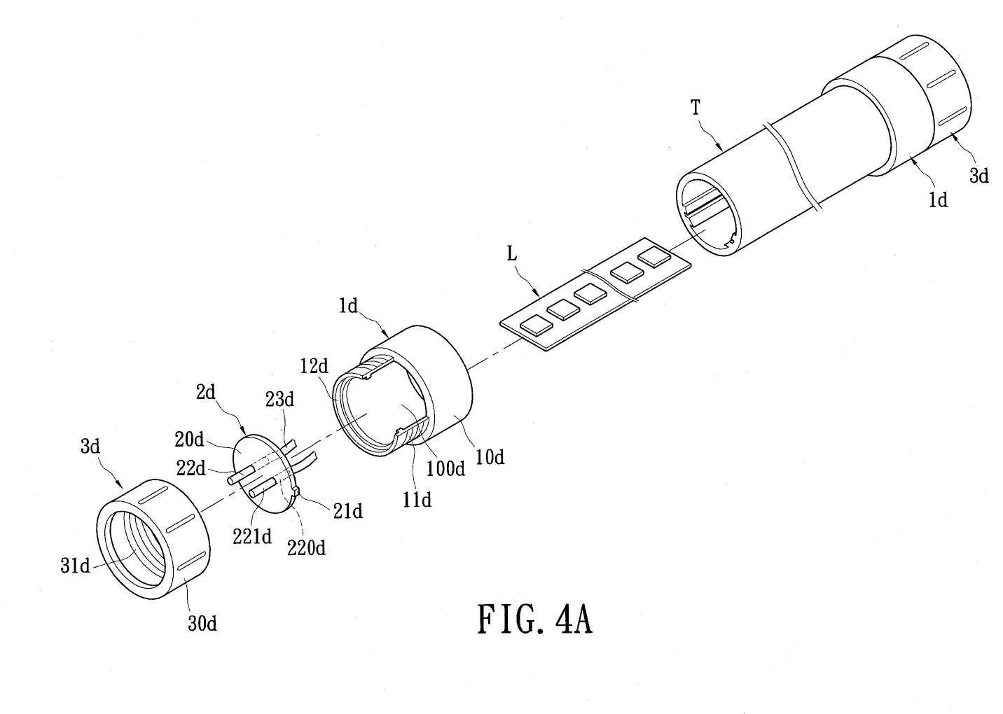

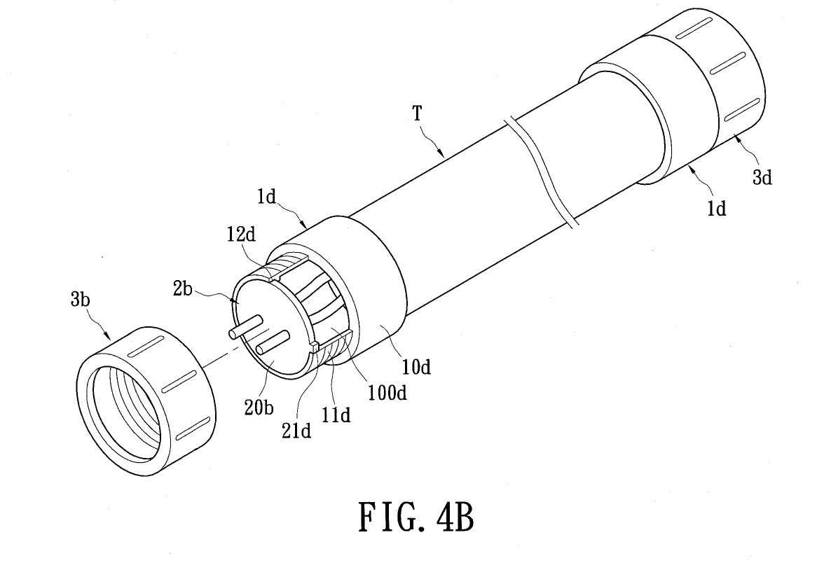

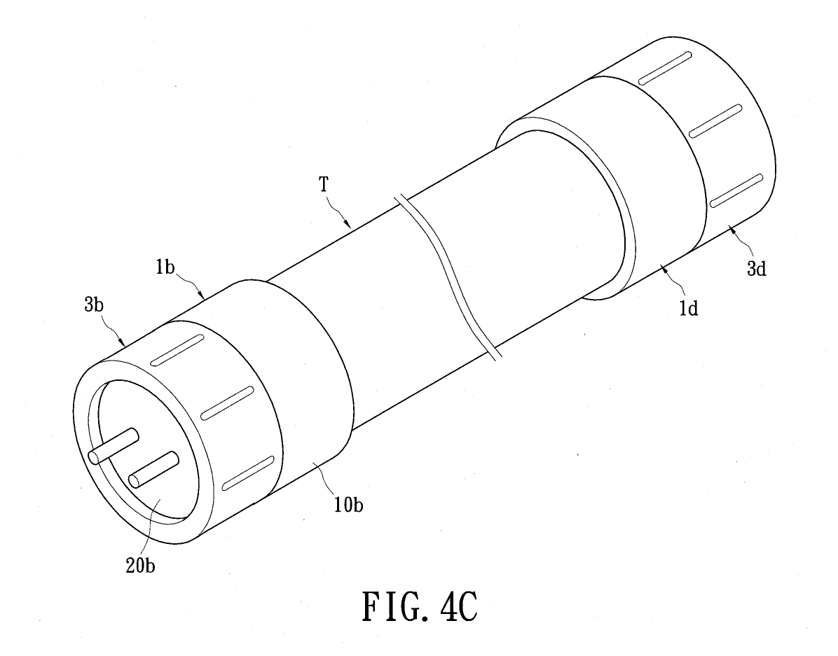

Referring to FIGS. 4A to 4C, the fourth embodiment of the present invention provides an LED lamp structure for adjusting assembly angle, including: a light-transmitting tube T, a light-emitting module L and two LED lamp adapters. The light-emitting module L is received and positioned in the light-transmitting tube T, and the two LED lamp adapters are respectively positioned on two opposite ends of the light-transmitting tube L.

Moreover, each LED lamp adapter includes a first assembly 1d, an adapter element 2d and a second assembly 3d.

The first assembly 1d has a first hollow body 10d, a locking structure 11d formed on one part of an outer surface of the first hollow body 10d, and a first retaining portion 12d disposed on an inner surface of the first hollow body 10d and adjacent to the locking structure 11d, and the first hollow body 10d has a positioning gap 100d passing therethrough and adjacent to the locking structure 11d.

The adapter element 2d has a substrate 20d rotatably disposed on the first retaining portion 12d, a second retaining portion 21d movably positioned in the gap 100d, at least two electrode pins 22d passing through the substrate 20d and combined with the substrate 20d, and at least two conductive wires 23d respectively electrically connected to two rear ends 220d of the at least two electrode pins 22d, and thus the positions of the two front ends 221d of the at least two electrode pins 22d relative to the first assembly 1d are adjustable by rotating the second retaining portion 21d in the gap 100d.

The first retaining portion 12d may be a retaining groove disposed on the inner surface of the first hollow body 10d, the second retaining portion 21d may be a retaining body extended outwards from a periphery of the substrate 20d, and thus the adapter element 2d is fixed on one lateral side of the first assembly 1d by selectively mating the retaining body with the retaining groove.

The second assembly 3d has a second hollow body 30d and a locking structure 31d formed on one part of an inner surface of the second hollow body 30d, and thereby the adapter element 2d is fixed between the first assembly 1d and the second assembly 2d by mating the locking structure 11d of the first assembly 1d with the locking structure 31d of the second assembly 3d.

Hence, the second retaining portion 21d can be movably positioned in the gap 100d without separating the first assembly 1d and the second assembly 2d from each other, and thus the positions of the two front ends 221d of the at least two electrode pins 22d relative to the first assembly 1d can be adjusted according to different requirements.

In conclusion, when each second assembly is rotated to separate from each first assembly, each adapter element can be rotated through any angle from 0˜180 degrees relative to each first assembly in order to adjust the assembly angle of every two electrode pins that would be electrically inserted in a lamp bracket without using any fixing element such as screw. Hence, the assembly angle of the LED lamp structure can be adjusted quickly in the present invention.

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

What is claimed is:

1. An LED lamp adapter, comprising:
a first assembly having a first hollow body, a locking structure formed on one part of an outer surface of the first hollow body, and a plurality of first retaining portions disposed on a lateral end of the first hollow body and adjacent to the locking structure;
an adapter element having a substrate, a plurality of second retaining portions selectively corresponding to the first retaining portions, at least two electrode pins passing through the substrate and combined with the substrate, and at least two conductive wires respectively electrically connected to two rear ends of the at least two electrode pins, wherein the positions of two front ends of the at least two electrode pins relative to the first assembly are adjustable by selectively mating the first retaining portions with the second retaining portions; and
a second assembly having a second hollow body and a locking structure formed on one part of an inner surface of the second hollow body, wherein the adapter element is fixed between the first assembly and the second assembly by mating the locking structure of the first assembly with the locking structure of the second assembly.

2. The LED lamp adapter as claimed in claim 1, wherein each first retaining portion is a retaining groove, each second retaining portion is a retaining body extended outwards from a periphery of the substrate, and the adapter element is fixed on one lateral side of the first assembly by selectively mating the retaining bodies with the retaining grooves.

3. The LED lamp adapter as claimed in claim 1, wherein each first retaining portion is a retaining groove, each second retaining portion is a retaining body extended rearwards from a lateral surface of the substrate, and the adapter element is fixed on one lateral side of the first assembly by selectively mating the retaining bodies with the retaining grooves.

4. The LED lamp adapter as claimed in claim 1, wherein each first retaining portion is a retaining body extended outwards from the lateral end of the first hollow body, each second retaining portion is a retaining groove concaved inwards from a periphery of the substrate, and the adapter element is fixed on one lateral side of the first assembly by selectively mating the retaining bodies with the retaining grooves.

5. The LED lamp adapter as claimed in claim 1, wherein the second hollow body of the second assembly has a plurality of stripped grooves disposed around an outer surface thereof.

6. An LED lamp structure, comprising:
a light-transmitting tube;
a light-emitting module received and positioned in the light-transmitting tube; and
two LED lamp adapters respectively positioned on two opposite ends of the light-transmitting tube, wherein each LED lamp adapter comprises:
a first assembly having a first hollow body, a locking structure formed on one part of an outer surface of the first hollow body, and a plurality of first retaining portions disposed on a lateral end of the first hollow body and adjacent to the locking structure;
an adapter element having a substrate, a plurality of second retaining portions selectively corresponding to the first retaining portions, at least two electrode pins passing through the substrate and combined with the substrate, and at least two conductive wires respectively electrically connected to two rear ends of the at least two electrode pins, wherein the positions of two front ends of the at least two electrode pins relative to the first assembly are adjustable by selectively mating the first retaining portions with the second retaining portions; and
a second assembly having a second hollow body and a locking structure formed on one part of an inner surface of the second hollow body, wherein the adapter element is fixed between the first assembly and the second assembly by mating the locking structure of the first assembly with the locking structure of the second assembly.

7. The LED lamp structure as claimed in claim 6, wherein each first retaining portion is a retaining groove, each second retaining portion is a retaining body extended outwards from a periphery of the substrate, and the adapter element is fixed on one lateral side of the first assembly by selectively mating the retaining bodies with the retaining grooves.

8. The LED lamp structure as claimed in claim 6, wherein each first retaining portion is a retaining groove, each second retaining portion is a retaining body extended rearwards from a lateral surface of the substrate, and the adapter element is fixed on one lateral side of the first assembly by selectively mating the retaining bodies with the retaining grooves.

9. The LED lamp structure as claimed in claim 6, wherein each first retaining portion is a retaining body extended outwards from the lateral end of the first hollow body, each second retaining portion is a retaining groove concaved inwards from a periphery of the substrate, and the adapter element is fixed on one lateral side of the first assembly by selectively mating the retaining bodies with the retaining grooves.

10. The LED lamp structure as claimed in claim 6, wherein the second hollow body of the second assembly has a plurality of stripped grooves disposed around an outer surface thereof.

11. An LED lamp adapter, comprising:
a first assembly having a first hollow body, a locking structure formed on one part of an outer surface of the first hollow body, and a first retaining portion disposed on an inner surface of the first hollow body and adjacent to the locking structure, wherein the first hollow body has a positioning gap;
an adapter element having a substrate rotatably disposed on the first retaining portion, a second retaining portion movably positioned in the gap, at least two electrode pins passing through the substrate and combined with the substrate, and at least two conductive wires respectively electrically connected to two rear ends of the at least two electrode pins, wherein the positions of two front ends of the at least two electrode pins relative to the first assembly are adjustable by rotating the second retaining portion in the gap; and
a second assembly having a second hollow body and a locking structure formed on one part of an inner surface of the second hollow body, wherein the adapter element is fixed between the first assembly and the second assembly by mating the locking structure of the first assembly with the locking structure of the second assembly.

12. The LED lamp adapter as claimed in claim 11, wherein the first retaining portion is a retaining groove, the second retaining portion is a retaining body extended outwards from a periphery of the substrate, and the adapter element is fixed on one lateral side of the first assembly by selectively mating the retaining body with the retaining groove.

13. An LED lamp structure, comprising:
a light-transmitting tube;
a light-emitting module received and positioned in the light-transmitting tube; and
two LED lamp adapters respectively positioned on two opposite ends of the light-transmitting tube, wherein each LED lamp adapter comprises:
a first assembly having a first hollow body, a locking structure formed on one part of an outer surface of the first hollow body, and a first retaining portion disposed on an inner surface of the first hollow body and adjacent to the locking structure, wherein the first hollow body has a positioning gap;
an adapter element having a substrate rotatably disposed on the first retaining portion, a second retaining portion movably positioned in the gap, at least two electrode pins passing through the substrate and combined with the substrate, and at least two conductive wires respectively electrically connected to two rear ends of the at least two electrode pins, wherein the positions of two front ends of the at least two electrode pins relative to the first assembly are adjustable by rotating the second retaining portion in the gap; and
a second assembly having a second hollow body and a locking structure formed on one part of an inner surface of the second hollow body, wherein the adapter element is fixed between the first assembly and the second assembly by mating the locking structure of the first assembly with the locking structure of the second assembly.

14. The LED lamp structure as claimed in claim 13, wherein the first retaining portion is a retaining groove, the second retaining portion is a retaining body extended outwards from a periphery of the substrate, and the adapter element is fixed on one lateral side of the first assembly by selectively mating the retaining body with the retaining groove.
